(19) United States
(12) Patent Application Publication
(10) Pub. No.: US 2007/0174609 A1
(43) Pub. Date: Jul. 26, 2007

(54) Apparatus and method for determining revocation key, and apparatus and method for decrypting contents using the same

(75) Inventors: Sung-hyu Han, Seoul (KR); Myung-sun Kim, Uiwang-si (KR); Young-sun Yoon, Suwon-si (KR); Sun-nam Lee, Suwon-si (KR); Jae-heung Lee, Suwon-si (KR); Bong-seon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/398,633

(22) Filed: Apr. 6, 2006

Related U.S. Application Data
(60) Provisional application No. 60/668,607, filed on Apr. 6, 2005.

(30) Foreign Application Priority Data
Jun. 24, 2005 (KR) 10-2005-0055124

(51) Int. Cl. H04N 7/16; H04L 9/32; H04L 9/00; G06F 17/30; G06F 7/04; G06K 9/00; H03M 1/68; H04K 1/00

(52) U.S. Cl. 713/167; 713/165; 726/26; 726/27; 726/28; 726/29; 713/181

(57) ABSTRACT

A revocation key determining method for content protection. The revocation key determining method includes: identifying at least one of a plurality of groups on the basis of a structure in which groups, each consisting of nodes to which key sets for content protection are respectively assigned, are hierarchically arranged in a tree form; and detecting whether nodes belonging to the group are respectively revoked.

### CROSS-REFERENCE TO RELATED PATENT APPLICATIONS

This application claims the benefit of U.S. Patent Application No. 60/668,607, filed on Apr. 6, 2005, in the United States Patent and Trademark Office, and Korean Patent Application No. 10-2005-0055124, filed on Jun. 24, 2005, in the Korean Intellectual Property Office, the disclosures of which are incorporated herein in their entirety by reference.

### BACKGROUND OF THE INVENTION

1. Field of the Invention

The present invention relates to digital content protection, and more particularly, to an apparatus and method for efficiently decrypting digital contents according to a broadcast encryption scheme.

2. Description of the Related Art

Recently, transmission of digital contents through various communication media, such as the Internet, ground waves, cables, satellites, etc., has rapidly increased. Along with this, the sale and lease of digital contents using high-capacity recording media, such as Compact Discs (CD's), Digital Versatile Discs (DVD's), etc., are rapidly becoming a common feature of every-day life. Accordingly, Digital Rights Management (DRM), which is a solution for copyright protection of digital contents, is becoming an important issue. In particular, research is being carried out on a broadcast encryption method for protecting widely-distributed digital contents by encrypting broadcasted digital contents using recording media, such as CD's, DVD's, etc., and the Internet, etc.

Generally, a conventional broadcast encryption method includes two encryption steps: encrypting contents using a content key; and encrypting the content key which has been used for content encryption using a revocation key for managing revocation of a device, a user, or a user group, etc. Also, in order to decrypt the contents encrypted according to the conventional broadcast encryption method, the encrypted content key is decrypted using the revocation key and the encrypted contents are decrypted using the decrypted content key.

Revocation keys are assigned to devices, users, user groups, etc. to which the conventional broadcast encryption method is applied. Devices which can no longer be protected by the broadcast encryption method due to disclosure of their revocation keys, etc., among devices based on the broadcast encryption method, are revoked. The revoked devices cannot decrypt contents based on the broadcast encryption method using their own revocation keys.

However, if the number of devices, users, or user groups to which the broadcast encryption method is applied increases, the number of revocation keys which must be assigned to the devices, the users, or the user groups, increases exponentially. For this reason, a Hierarchical Hash-Chain Broadcast Encryption Scheme (HBES) has been developed as a modified broadcast encryption method for resolving the above-identified problem.

FIG. 1 is a view illustrating a conventional HBES key tree.

Referring to FIG. 1, the conventional HBES key tree is an L-layer N-ary tree, wherein groups, each comprising nodes to which HBES node key sets being revocation keys are respectively assigned, are hierarchically arranged. Each node belonging to the groups in the HBES key tree corresponds to a device, a user, or a user group, etc., and a HBES node key set is assigned to each node.

Specifically, a HBES node key set consists of a seed value and values obtained by respectively hashing the seed value and different seed values at different times. In more detail, a first seed value and values obtained by serially hashing the first seed value are respectively assigned to the respective nodes belonging to any one of the groups in the HBES key tree, and a second seed value and values obtained by serially hashing the second seed value are respectively assigned to the respective nodes in an order shifted by one node. This process is repeated until a final seed value and values obtained by serially hashing the final seed value are respectively assigned to the respective nodes of the corresponding group.

As such, the HBES substitutes hash processes using hash values of HBES node key sets for most encryption processes using revocation keys using the conventional broadcast encryption method. Therefore, the HBES has simpler calculation and a lower amount of transmission data and storage data, compared to the conventional broadcast encryption method.

FIG. 2 is a view illustrating an example of a conventional HBES key tree.

Referring to FIG. 2, the HBES key tree is a 3-layer 4-ary tree. Specifically, portions denoted by “x” among nodes belonging to groups in the HBES key tree are revoked HBES node key sets.

In the conventional HBES key tree, information regarding the revocation of HBES node key sets includes the ID's of groups including at least one node (that is, revocation node) to which at least one revoked HBES node key set is assigned, and the start locations and the lengths of intervals in each of which non-revoked nodes among nodes of each of the groups successively appear. Such information regarding the HBES key tree illustrated in FIG. 2 can be represented as follows.
Group ID=0, start location and length of the interval=[1, 2]
Group ID=1, start location and length of the interval=[3, 3]
Group ID=4, start location and length of the interval=[2, 3]
Group ID=7, start location and length of the interval=[3, 3]
Group ID=18, start location and length of the interval=[4, 3]

The actual start location and length of an interval are represented by the numerals 1 through 4, but can also be represented by 2 bits representing binary values 0 through 3 corresponding to 1 through 4.

In the HBES key tree which is a 3-layer 4-ary type as described above, five bits are required for representing all group ID's. However, the conventional HBES key tree has the disadvantage that the number of bits required for representing all group ID's significantly increases as the values of L and N increase. For example, in a HBES key tree which is a 16-layer 16-ary type, 61 bits are required for representing all group ID's.

### SUMMARY OF THE INVENTION

The present invention provides an apparatus and method which are capable of reducing the size of a tag storing information regarding the revocation of HBES node keys, by removing group ID's which require a large number of bits in a conventional HBES key tree structure, and a computer-readable recording medium storing a data structure therefor. The present invention also provides a computer-readable recording medium having embodied thereon a computer program for executing the method.

According to an aspect of the present invention, there is provided a revocation key determining method comprising: identifying at least one of a plurality of groups based on a structure in which the plurality of groups, each comprising nodes to which key sets for content protection are respectively assigned, are hierarchically arranged in a tree form; detecting whether a node in the at least one identified group is revoked; and determining whether a key set assigned to the node is revoked according to the detected result.

According to another aspect of the present invention, there is provided a revocation key determining apparatus comprising: an identifying unit which identifies at least one of a plurality of groups based on a structure in which the plurality of groups, each comprising nodes to which key sets for content protection are respectively assigned, are hierarchically arranged in a tree form; a detector which detects whether a node belonging to the at least one group identified by the identifying unit is revoked; and a determining unit which determines whether the key set assigned to the node is revoked according to the result detected by the detector.

According to another aspect of the present invention, there is provided a computer-readable recording medium having embodied thereon a computer program for executing the revocation key determining method.

According to another aspect of the present invention, there is provided a decryption method comprising: identifying at least one of a plurality of groups based on a structure in which the plurality of groups, each comprising nodes to which key sets for content protection are respectively assigned, are hierarchically arranged; detecting whether a node belonging to the identified group is revoked; determining whether the key set assigned to the node is revoked according to the detected result; and decrypting encrypted content using a key set determined as a non-revoked key set.

According to another aspect of the present invention, there is provided a decryption apparatus comprising: an identifying unit which identifies at least one of a plurality of groups based on a structure in which the plurality of groups, each comprising nodes to which key sets for content protection are respectively assigned, are hierarchically arranged in a tree form; a detector which detects whether a node belonging to the group identified by the identifying unit is revoked; a determining unit which determines whether the key set assigned to the node is revoked according to the result detected by the detector; and a decrypting unit which decrypts encrypted content using a key set determined as a non-revoked key set.

According to another aspect of the present invention, there is provided a computer-readable recording medium having embodied thereon a computer program for executing the decryption method.

According to another aspect of the present invention, there is provided a computer-readable recording medium storing a data structure, the data structure comprising: a first field which indicates whether information regarding descendent groups of one of a plurality of groups of nodes to which key sets for content protection are respectively assigned, is terminated; and a second field which indicates whether nodes belonging to the group of the plurality of groups are respectively revoked.

### BRIEF DESCRIPTION OF THE DRAWINGS

The above and other features of the present invention will become more apparent by describing in detail exemplary embodiments thereof with reference to the attached drawings in which:

FIG. 1 is a view illustrating a conventional HBES key tree;

FIG. 2 is a view illustrating an example of a conventional HBES key tree;

FIG. 3 is a view illustrating a packet format according to an exemplary embodiment of the present invention;

FIG. 4 is a block diagram of a revocation key determining apparatus according to an exemplary embodiment of the present invention;

FIG. 5 is a view illustrating a HBES key tree according to a first exemplary embodiment of the present invention;

FIG. 6 is a view illustrating a HBES key tree according to a second exemplary embodiment of the present invention;

FIG. 7 is a view illustrating a HBES key tree according to a third exemplary embodiment of the present invention;

FIG. 8 is a view illustrating a HBES key tree according to a fourth exemplary embodiment of the present invention;

FIG. 9 is a table in which the sizes of tags according to the first through fourth exemplary embodiments of the present invention are compared with the sizes of tags according to the conventional technique;

FIG. 10 is a block diagram of a decryption apparatus according to an exemplary embodiment of the present invention;

FIG. 11 is a flowchart illustrating a revocation key determining method according to an exemplary embodiment of the present invention; and

FIGS. 12A and 12B are flowcharts illustrating a decryption method according to an exemplary embodiment of the present invention.

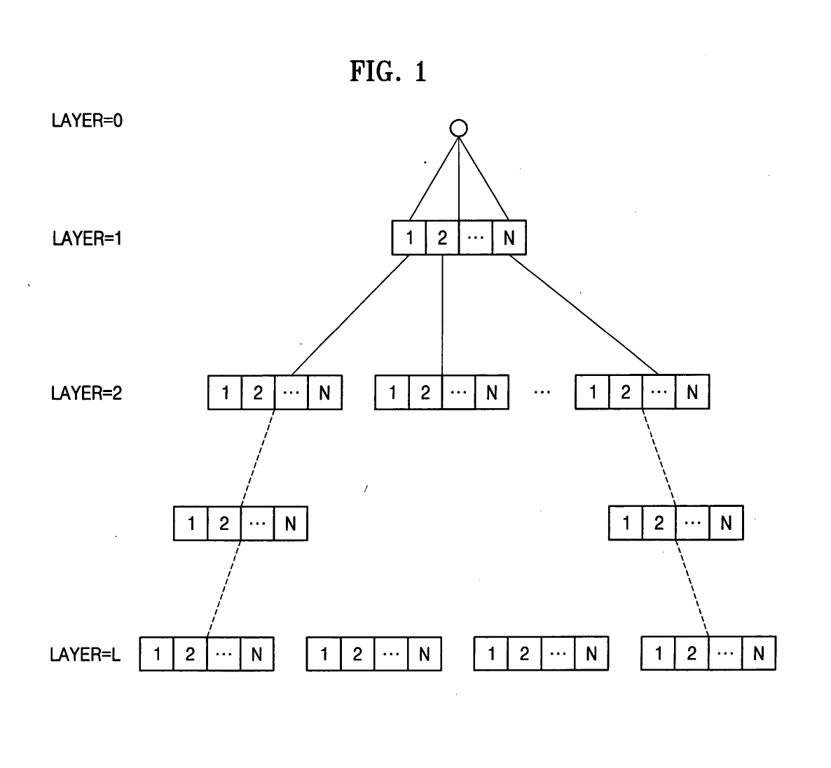

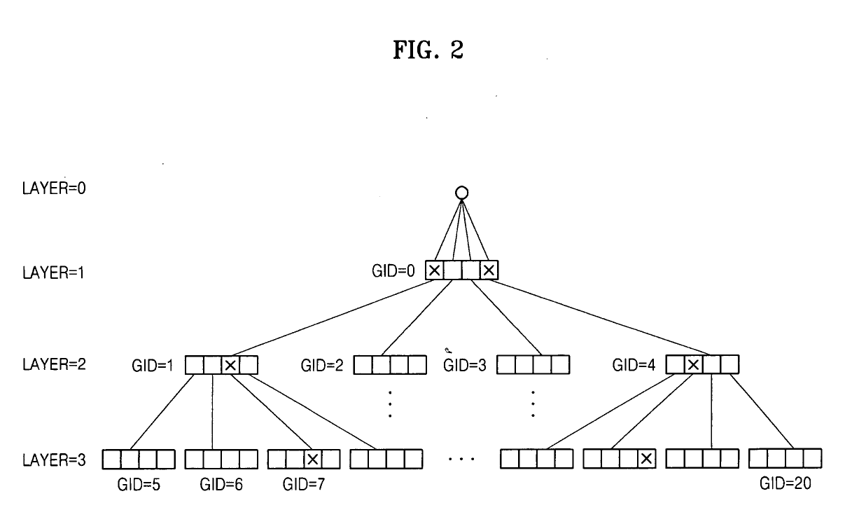

### DETAILED DESCRIPTION OF THE EXEMPLARY EMBODIMENTS

The present invention will now be described more fully with reference to the accompanying drawings, in which exemplary embodiments of the invention are shown.

A Hierarchical Hash-Chain Broadcast Encryption Scheme (HBES) key tree according to an exemplary embodiment of the present invention has a structure in which groups, each consisting of nodes to which HBES node key sets being revocation keys are respectively assigned, are hierarchically arranged in a L-layer N-ary tree form. Also, each node belonging to groups in the HBES key tree corresponds to a device, a user, or a user group, and a HBS node key set is assigned to each node.

Specifically, a HBES node key set consists of a seed value and values obtained by respectively hashing the seed value and different seed values at different times. In more detail, a first seed value and values obtained by serially hashing the first seed value are respectively assigned to the respective nodes belonging to any one of the groups in the HBES key tree, and a second seed value and values obtained by serially hashing the second seed value are respectively assigned to the respective nodes in an order shifted by one node. This process is repeated until a final seed value and values obtained by serially hashing the final seed value are respectively assigned to the respective nodes of the corresponding group.

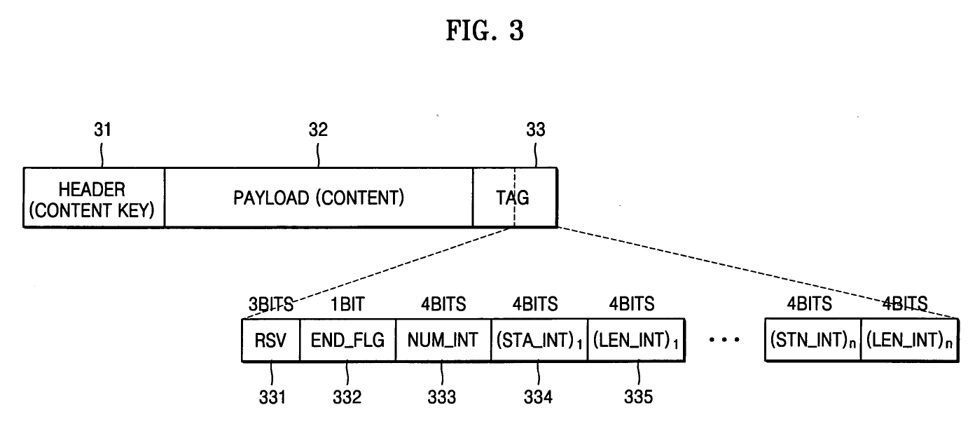

FIG. 3 is a view illustrating a packet format according to an exemplary embodiment of the present invention.

Referring to FIG. 3, the packet includes a header 31, a payload 32, and a tag 33.

The header 31 includes a field in which a serial number representing the order of packet transmission is recorded, a field in which the number of content keys used for encrypting contents is recorded, and a field in which content keys encrypted by HBES node key sets are recorded. The HBES node key sets are respectively assigned to nodes belonging to groups in the HBES key tree.

The payload 32 includes a content field in which contents encrypted by the content keys are recorded.

The tag 33 includes a reservation field 331, an end flag field 332, an interval count field 333, an interval start field 334, and an interval length field 335.

The reservation field 331, which stores no value, is created because computers, embedded systems, etc. generally process data in units of at least four bits. That is, the reservation field 331 is a field corresponding to the remaining three bits created because the length of the end flag field 332 is one bit.

The end flag field 332 stores a value indicating whether information regarding descendent groups of a group in the HBES key tree is terminated. In more detail, if a group in the HBES key tree is a “Leaf” group, if all nodes belonging to descendent groups of a group in the HBES key tree are revoked, or if no node belonging to descendent groups of a group in the HBES key tree is revoked, a value indicating that information regarding the descendent groups of the corresponding group in the HBES key tree is terminated is recorded in the end flag field 332.

The interval count field 333, the interval start field 334, and the interval length field 335 are used for indicating whether nodes belonging to a group in the HBES key tree are respectively revoked. The interval count field 333, the interval start field 334, and the interval length field 335 will be described in detail below.

The interval count field 333 stores the number of intervals in which each of non-revoked nodes among nodes belonging to a group in the HBES key tree successively appear.

The interval start field 334 stores the start location value of an interval in which the non-revoked nodes among the nodes belonging to the group in the HBES key tree successively appear.

The interval length field 335 stores the length of an interval in which the non-revoked nodes among the nodes belonging to the group of the HBES key tree successively appear.

The number of the interval start fields 334 and the number of the interval length fields 335 correspond to the number of intervals stored in the interval count field 333. For example, if the number of intervals stored in the interval count field 333 is two, two interval start fields and two interval length fields are successively provided. If the number of intervals stored in the interval count field 333 is zero, no interval start field and no interval length field exist.

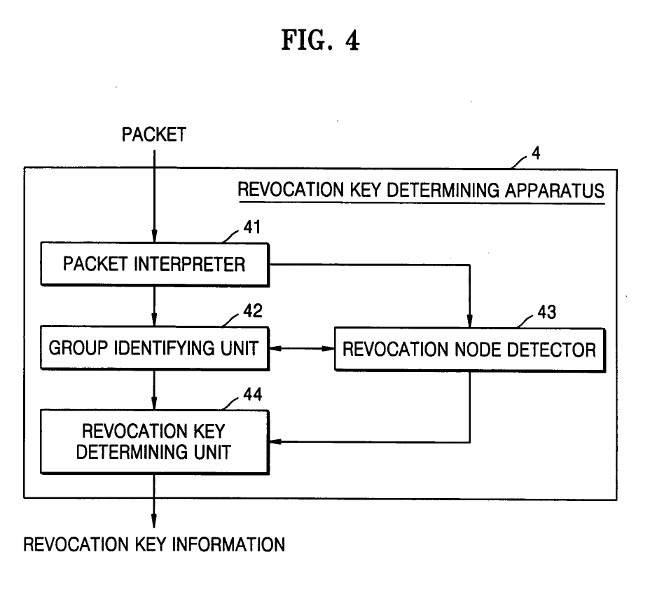

FIG. 4 is a block diagram of a revocation key determining apparatus 4 according to an exemplary embodiment of the present invention.

Referring to FIG. 4, the revocation key determining apparatus 4 includes a packet interpreter 41, a group identifying unit 42, a revocation node detector 43, and a revocation key determining unit 44.

The packet interpreter 41 interprets a packet as illustrated in FIG. 3 and determines the structure of the packet according to the interpreted result. In more detail, the packet interpreter 41 interprets a packet as illustrated in FIG. 3 and determines that the packet is composed of a header 31, a payload 32, and a tag 33 according to the interpreted result. Then, the packet interpreter 41 interprets the tag 33 and determines that the tag 33 is composed of a reservation field 331, an end flag field 332, an interval count field 333, an interval start field 334, and an interval length field 335 according to the interpreted result.

The group identifying unit 42 identifies at least one of a plurality of groups in the HBES key tree, based on a HBES key tree structure determined according to the interpreted result of the packet interpreter 41, that is, based on a structure in which groups, each consisting of nodes to which HBES node key sets are respectively assigned, are hierarchically arranged in an L-layer N-ary tree structure.

In more detail, the group identifying unit 42 identifies at least one group corresponding to the nearest lower layer of the layers on the basis of the locations of nodes belonging to a group corresponding to any one of a plurality of L layers. That is, the group identifying unit 42 identifies a first group determined according to the interpreted result of the packet interpreter 41, as a group corresponding to a first layer among a plurality of groups in the HBES key tree. Then, the group identifying unit 42 identifies groups corresponding to a second layer which is the layer immediately below the first layer, on the basis of the locations of nodes of the first layer. For example, the group identifying unit 42 identifies a descendent group of the left most node among nodes belonging to a group corresponding to the first layer, as the left most group of groups corresponding to the second layer.

The revocation node detector 43 detects whether the respective nodes are revoked based on information regarding the interval of at least one non-revoked node of nodes belonging to the at least one group identified by the group identifying unit 42. That is, the revocation node detector 43 detects whether nodes belonging to the group identified by the group identifying unit 42 are revoked, with reference to values recorded in the interval count field 333, the interval start field 334, and the interval length field 335, among the fields of the tag 33 determined according to the interpreted result of the packet interpreter 41.

Also, the revocation node detector 43 detects whether information regarding descendent groups of the group identified by the group identifying unit 42 is terminated, with reference to a value recorded in the end flag field 332 among the fields of the tag 33 determined according to the interpreted result of the packet interpreter 41. In more detail, the revocation node detector 43 detects that the information regarding the descendent groups of the group identified by the group identifying unit 42 is terminated if a value recorded in the end flag field 332 indicates that the information regarding the descendent groups of the group identified by the group identifying unit 42 is terminated, that is, if the group identified by the group identifying unit 42 is a “Leaf” group, if all nodes belonging to the descendent groups of the group identified by the group identifying unit 42 are revoked, or if no node belonging to the descendent groups of the group identified by the group identifying unit 42 is revoked.

The revocation key determining unit 44 determines whether r HBES node key sets respectively assigned to the nodes belonging to the group identified by the group identifying unit 42 are revoked, according to the result detected by the revocation node detector 43. That is, the revocation key determining unit 44 determines that HBES node key sets respectively assigned to nodes detected as revocation nodes by the revocation node detector 43 among HBES node key sets respectively assigned to the nodes belonging to the group identified by the group identifying unit 42, are revoked.

Also, if the revocation node detector 43 detects that information regarding the descendent groups of the group identified by the group identifying unit 42 is terminated, the revocation key determining unit 44 determines at once whether HBES node key sets assigned to all nodes belonging to the descendent groups of the node are revoked according to whether each node belonging to the group identified by the group identifying unit 42 is revoked. That is, if the group identified by the group identifying unit 42 is a “Leaf” group, if all nodes belonging to the descendent groups of the group identified by the group identifying unit 42 are revoked, or if no node belonging to the descendent groups of the group identified by the group identifying unit 42 is revoked, the revocation key determining unit 44 determines at once whether HBES node key sets respectively assigned to all nodes belonging to the descendent groups of the node are respectively revoked, according to whether each node belonging to the group identified by the group identifying unit 42 is revoked.

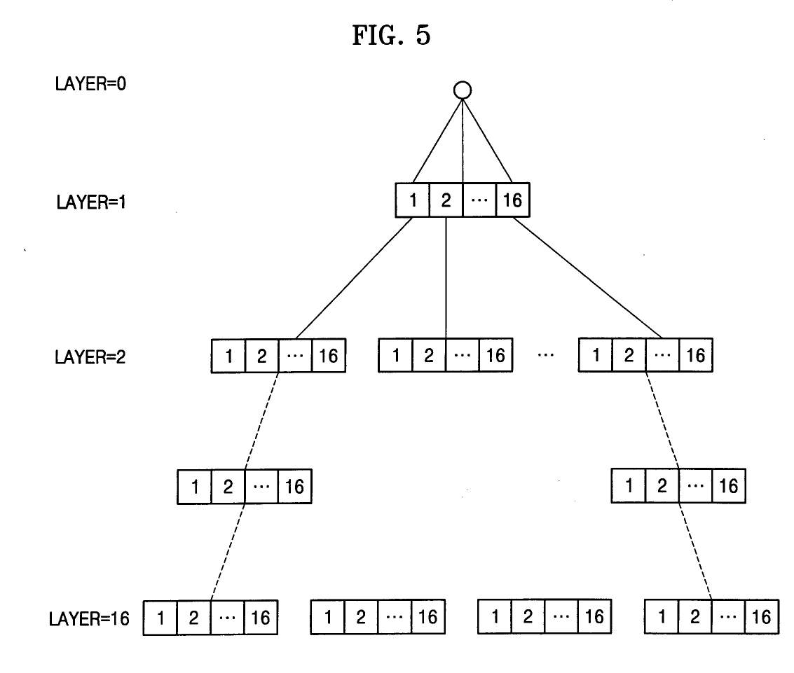

FIG. 5 is a view illustrating a HBES key tree according to a first exemplary embodiment of the present invention.

Referring to FIG. 5, the HBES key tree according to the first exemplary embodiment of the present invention is a 16-layer 16-ary tree. In the HBES key tree illustrated in FIG. 5, HBES node key sets respectively assigned to all nodes belonging to groups in the HBES key tree are not revoked.

The state of the HBES key tree is represented using a tag 33 illustrated in FIG. 3, as follows. A tag 33 for a group corresponding to a first layer consists of: a reservation field 331=0, an end flag field 332=1, an interval count field 333=1, an interval start field 334=0, and an interval length field 335=15.

The actual start location and length of an interval are represented by 1 through 16, but, these can be represented by 4 bits representing binary values 0 through 15 corresponding to 1 through 16.

The packet interpreter 41 interprets the tag 33 for the group corresponding to the first layer and determines that the tag 33 is composed of a reservation field 331=0, an end flag field 332=1, an interval count field 333 =1, a field start field 334=0, and an interval length field 335=15, according to the interpreted result.

The group identifying unit 42 identifies the first group determined according to the interpreted result of the packet interpreter 41, as a group corresponding to the first layer among the groups in the HBES key tree.

The revocation node detector 43 detects that no node corresponding to the first layer identified by the group identifying unit 42 is revoked, with reference to the interval count field 333=1, the interval start field 334=0, and the interval length field 335=15, determined according to the interpreted result of the packet interpreter 41.

Also, the revocation node detector 43 determines that information regarding the descendent groups of the group corresponding to the first layer identified by the group identifying unit 42 is terminated, with reference to the end flag field 332=1 determined according to the interpreted result of the packet interpreter 41. Specifically, the current exemplary embodiment of the present invention is a case where no node belonging to all descendent groups of a group identified by the group identifying unit 42 is revoked.

The revocation key determining unit 44 determines that no HBES node key set assigned to the respective nodes belonging to the group corresponding to the first layer identified by the group identifying unit 42 is revoked, according to the result detected by the revocation node detector 43.

Also, if the revocation node detector 43 detects that information regarding the descendent groups of the group corresponding to the first layer is terminated, the revocation key determining unit 44 determines at once that no HBES node key set assigned to the respective nodes belonging to the descendent groups is revoked, according to the detection result of the revocation node detector 43 indicating that no node belonging to the group corresponding to the first layer is revoked.

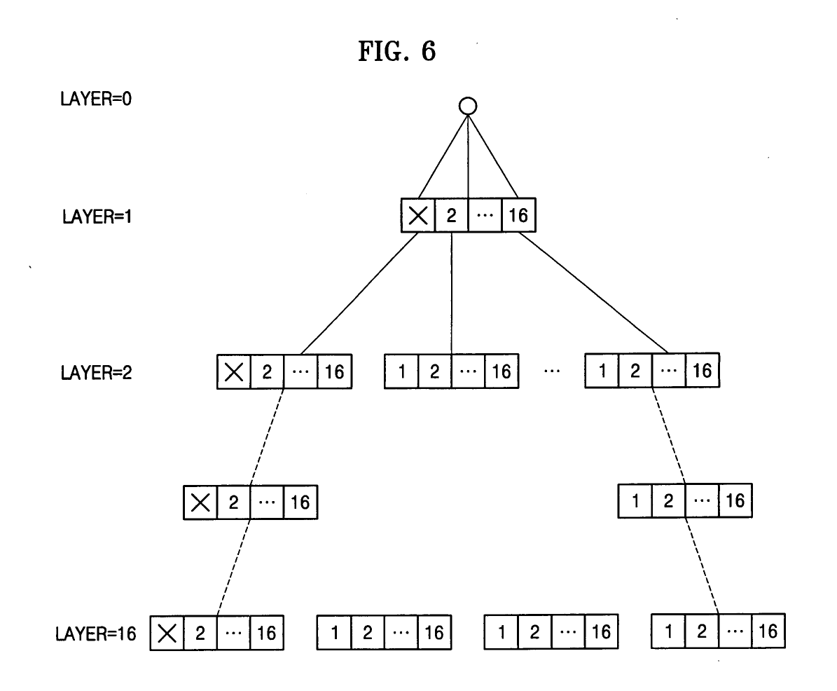

FIG. 6 is a view illustrating a HBES key tree according to a second exemplary embodiment of the present invention.

Referring to FIG. 6, in the HBES key tree, only a HBES node key set assigned to the left most group of each layer, specifically, only a HBES node key set assigned to the left most node of nodes belonging to the left most group of each layer is revoked, and the remaining nodes are not revoked.

The HBES key tree structure can be represented using a tag 33 illustrated in FIG. 3, as follows. A tag 33 for a group corresponding to a first layer consists of a reservation field 331=0, an end flag field 332=0, an interval count field=1, an interval start field 334=1, and an interval length field 335=14. A tag 33 for the left most group among groups corresponding to a second layer consists of a reservation field 331=0, an end flag field 332=0, an interval count field 333=1, an interval start field 334=1, and an interval length field 335=14. Tags 33 for the left most groups among groups corresponding to the third through fifteenth layers are the same as that described above. Also, a tag 33 for the left most group of groups corresponding to the sixteenth layer consists of a reservation field 331=0, an end flag field 332=1, an interval count field 333=1, an interval start field 334=1, and an interval length field 335=14.

The packet interpreter 41 interprets the tag 33 for the group corresponding to the first layer, and determines that the tag 33 for the group corresponding to the first layer consists of a reservation field 331=0, an end flag field 32=0, an interval count field 333=1, an interval start field 334=1, and an interval length field 335=14 according to the interpreted result.

The group identifying unit 42 identifies the first group determined according to the interpreted result of the packet interpreter 41 as a group corresponding to the first layer among groups in the HBES key tree.

The revocation node detector 43 detects that the left most node of nodes of the group belonging to the first layer identified by the group identifying unit 42 is revoked, with reference to the interval count field 333=1, the interval start field 334=1, and the interval length field 335=14 determined according to the interpreted result of the packet interpreter 41.

Also, the revocation node detector 43 detects that information regarding descendent groups of the group corresponding to the first layer identified by the group identifying unit 42 is not terminated, with reference to the end flag field 332=0 determined according to the interpreted result of the packet interpreter 41.

The revocation key determining unit 44 determines that a HBES node key set assigned to the left most node of the nodes of the group belonging to the first layer identified by the group identifying unit 42 according to the result detected by the revocation node detector 43, is revoked.

Then, the packet interpreter 41 interprets a tag 33 for a group corresponding to the second layer, and determines that the tag 33 for the group corresponding to the second layer consists of a reservation field 331=0, an end flag field 332=0, an interval count field 333=1, an interval start field 334=1, and an interval length field 335=14 according to the interpreted result.

The group identifying unit 42 identifies the second group as the left most group of groups corresponding to the second layer, with reference to the detection result indicating that an ascendant node of the second group determined according to the interpreted result of the packet interpreter 41, that is, a node detected as a revocation node by the revocation node detector 43 is the left most node of nodes belonging to the group corresponding to the first layer.

The revocation node detector 43 detects that the left most node of nodes belonging to the left most group of groups corresponding to the second layer identified by the group identifying unit 42 is revoked, with reference to the interval count field 333=1, the interval start field 334=1, and the interval length field 335=14, determined according to the interpreted result of the packet interpreter 41.

Also, the revocation node detector 43 detects that information regarding descendent groups of the group corresponding to the second layer identified by the group identifying unit 42 is not terminated, with reference to the end flag field 332=0 determined according to the interpreted result of the packet interpreter 41.

The revocation key determining unit 44 determines that a HBES node key set assigned to the left most node of nodes belonging to the left most group of groups belonging to the second layer identified by the group identifying unit 42 is revoked, according to the result detected by the revocation node detector 43.

Then, with respect to tags 33 for groups corresponding to the third through fifteenth layers, it is determined by the packet interpreter 41, the group identifying unit 42, the revocation node detector 43, and the revocation key determining unit 44 that the left most group of groups corresponding to each layer, specifically, the left most node of nodes belonging to groups corresponding to each layer is revoked.

Then, the packet interpreter 41 interprets a tag for a group corresponding to the sixteenth layer, and determines that the tag 33 for the group corresponding to the second layer is composed of a reservation field 331 =0, an end flag field 332=1, an interval count field 333=1, an interval start field 334=1, and an interval length field=14 according to the interpreted result.

The group identifying unit 42 identifies the second group as the left most group of groups belonging to the sixteenth layer, with reference to a detection result indicating that an ascendant node of the second group determined according to the interpreted result of the packet interpreter 41, that is, a node detected as a revocation node by the revocation node detector 43 is the left most node of nodes belonging to a group corresponding to the fifteenth layer.

The revocation node detector 43 detects that the left most group of the groups belonging to the sixteenth layer identified by the group identifying unit 42, specifically, the left most node of nodes belonging to the left most group is revoked, with reference to the interval count field 333=1, the interval start field 334=1, and the interval length field 335=14, determined according to the interpreted result of the packet interpreter 41.

Also, the revocation node detector 43 detects that information regarding all descendent groups of the left most group of groups corresponding to the sixteenth layer identified by the group identifying unit 42 is terminated, with reference to the end flag field 332=1 determined according to the interpreted result of the packet interpreter 41. Specifically, this exemplary embodiment is a case where the left most group of groups corresponding to a sixteenth layer identified by the group identifying unit 42 is a “Leaf” group.

The revocation key determining unit 44 determines that a HBES node key set assigned to the left most group of groups corresponding to the sixteenth layer identified by the group identifying unit 42, specifically, a HBES node key set assigned to the left most node of nodes belonging to the left most group is revoked, according to the result detected by the revocation node detector 43.

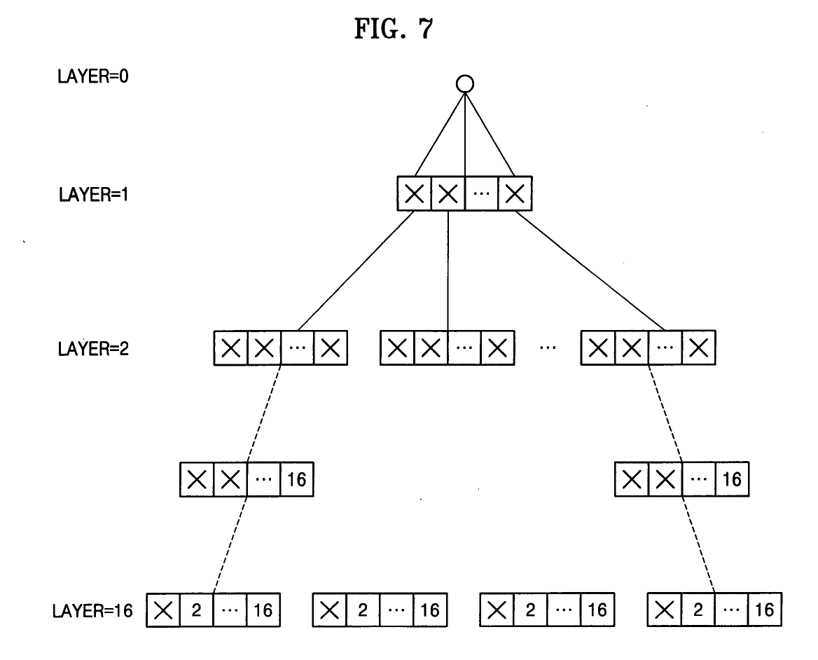

FIG. 7 is a view illustrating a HBES key tree according to a third exemplary embodiment of the present invention.

Referring to FIG. 7, a HBES node key set assigned to the left most node of nodes belonging to each group in the sixteenth layer of the HBES key tree is revoked and the remaining HBES node key sets are not revoked.

The HBES key tree structure is represented using a tag 33 illustrated in FIG. 3, as follows. A tag 33 for a group corresponding to a first layer consists of a reservation field 331=0, an end flag field 332=0, and an interval count field 333=0. Each of tags 33 for groups corresponding to a second layer consists of a reservation field 331=0, an end flag field 332=0, and an interval count field 333=0. Tags 33 for groups corresponding to third through fifteenth layers can be described according to their specific situations.

The packet interpreter 41 interprets a tag 33 for a group corresponding to the first layer, and determines that the tag 33 for the group corresponding to the first layer is composed of a reservation field 331=0, an end flag field 332=0, and an interval count field 333=0 according to the interpreted result.

The group identifying unit 42 identifies the first group determined according to the interpreted result of the packet interpreter 41 as a group corresponding to the first layer among groups in the HBES key tree.

The revocation node detector 43 detects that all nodes belonging to the group corresponding to the first layer identified by the group identifying unit 42 are revoked, with reference to the interval count field 333=0 determined according to the interpreted result of the packet interpreter 41.

Also, the revocation node detector 43 detects that information regarding descendent groups of the group corresponding to the first layer identified by the group identifying unit 42 is not terminated, with reference to the end flag field 332=0 determined according to the interpreted result of the packet interpreter 41.

The revocation key determining unit 44 determines that all HBES node key sets assigned to the nodes belonging to the group corresponding to the first layer identified by the group identifying unit 42 are revoked, according to the result detected by the revocation node detector 43.

Then, the packet interpreter 41 interprets a tag 33 for a group corresponding to a second layer, and determines that the tag 33 for the group corresponding to the second layer consists of a reservation field 331=0, an end flag field 332=0, and an interval count field 333=0, according to the interpreted result.

The group identifying unit 42 identifies the second group as the left most group of groups corresponding to the second layer, with reference to a detection result indicating that an ascendant node of the second group determined according to the interpreted result of the packet interpreter 41, that is, a node detected as a revoked node by the revocation node detector 43 is the left most one of nodes belonging to the group corresponding to the first layer.

The revocation node detector 43 detects that all nodes belonging to the left most group corresponding to the second layer identified by the group identifying unit 42 are revoked, with reference to the interval count field 333=0 determined according to the interpreted result of the packet interpreter 41.

Also, the revocation node detector 43 detects that information regarding descendent groups of the group corresponding to the first layer identified by the group identifying unit 42 is not terminated, with reference to the end flag field 332=0 determined according to the interpreted result of the packet interpreter 41.

The revocation key determining unit 44 determines that all HBES node key sets assigned to the nodes belonging to the first layer identified by the group identifying unit 42 are revoked, according to the result detected by the revocation node detector 43.

Thereafter, with respect to tags 33 for groups other than the above-described group, it is determined by the packet interpreter 41, the group identifying unit 42, the revocation node detector 43, and the revocation key determining unit 44 whether HBES node key sets assigned to nodes belonging to the groups are revoked according to their specific situations.

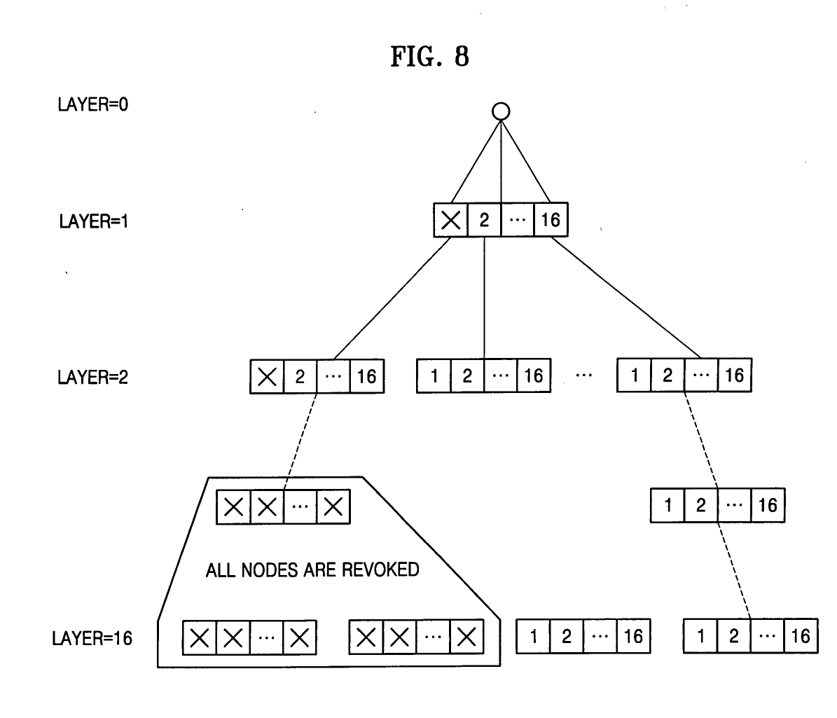

FIG. 8 is a view illustrating a HBES key tree according to a fourth exemplary embodiment of the present invention.

Referring to FIG. 8, in the left most group of groups of a second layer of the HBES key tree, HBES node key sets assigned to nodes belonging to all descendent groups of the left most node of nodes belonging to the left most group are revoked, and the remaining HBES node key sets are not revoked.

The HBES key tree is represented using a tag 33 shown in FIG. 3, as follows. A tag 33 for a group corresponding to a first layer is composed of a reservation field 331=0, an end flag field 332=0, an interval count field 333=1, an interval start field 334=1, and an interval length field 335=14. A tag 33 for the left most group of groups corresponding to a second layer is composed of a reservation field 331=0, an end flag field 332=1, an interval count field 333=1, an interval start field 334=1, and an interval length field 335=14.

The packet interpreter 41 interprets the tag 33 for the group corresponding to the first layer, and determines that the tag 33 for the group corresponding to the first layer is composed of a reservation field 331=0, an end flag field 332=0, an interval count field 333=1, an interval start field 334=1, and an interval length field 335=14 according to the interpreted result.

The group identifying unit 42 identifies the first group determined according to the interpreted result of the packet interpreter 41 as a group corresponding to the first layer among groups in the HBES key tree.

The revocation node detector 43 detects that the left most node of nodes belonging to the first layer identified by the group identifying unit 42 is revoked, with reference to the interval count field 333=1, the interval start field 334=1, and the interval length field 335=14, determined according to the interpreted result of the packet interpreter 41.

Also, the revocation node detector 43 detects that information regarding descendent groups of the group corresponding to the first layer identified by the group identifying unit 42 is not terminated, with reference to the end flag field 332=0 determined according to the interpreted result of the packet interpreter 41.

The revocation key determining unit 44 determines that a HBES node key set assigned to the left most node of nodes belonging to the group corresponding to the first layer identified by the group identifying unit 42 is revoked, according to the result detected by the revocation node detector 43.

Then, the packet interpreter 41 interprets a tag 33 for the left most group of groups belonging to a second layer, and determines that the tag 33 for the left most group corresponding to the second layer is composed of a reservation field 331=0, an end flag field 332=1, an interval count field 333 =1, an interval start field 334=1, and an interval length field 335=14 according to the interpreted result.

The group identifying unit 42 identifies the second group as the left most group of groups corresponding to the second layer, with reference to a detection result indicating that an ascendant node of the second group determined according to the interpreted result of the packet interpreter 41, that is, a node detected as a revoked node by the revocation node detector 43 is the left most node of nodes belonging to the group corresponding to the first layer.

The revocation node detector 43 detects that the left most group of groups corresponding to the second layer identified by the group identifying unit 42, specifically, the left most node of nodes belonging to the left most group is revoked, with reference to the interval count field 333=1, the interval start field 334=1, and the interval length field 335=14 determined according to the interpreted result of the packet interpreter 41.

Also, the revocation node detector 43 detects that information regarding all descendent groups of the group corresponding to the second layer identified by the group identifying unit 42 is terminated, with reference to the end flag field 332=1 determined according to the interpreted result of the packet interpreter 41. Specifically, this exemplary embodiment is a case where all nodes belonging to all descendent groups of the group identified by the group identifying unit 42 are revoked.

The revocation key determining unit 44 determines that a HBES node key set assigned to the left most group of groups corresponding to the second layer identified by the group identifying unit 42, specifically, a HBES node key set assigned to the left most node of nodes belonging to the left most group is revoked, according to the result detected by the revocation node detector 43. Also, if it is determined by the revocation node detector 43 that information regarding all descendent groups of the left most group of groups corresponding to the second layer is terminated, the revocation key determining unit 44 determines at once that all HBES node key sets assigned to nodes belonging to the descendent groups are revoked, according to the detected result indicating that all nodes belonging to the groups corresponding to the second layer are revoked.

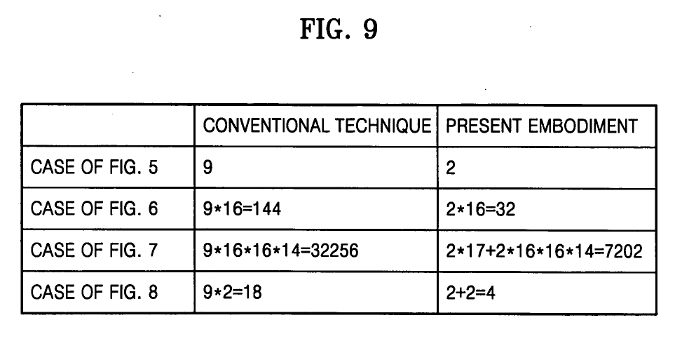

FIG. 9 is a table in which the sizes of tags according to the first through fourth exemplary embodiments of the present invention are compared with the sizes of tags according to the conventional technique;

It is seen in FIG. 9 that the sizes of tags according to the exemplary embodiments illustrated in FIGS. 5, 6, 7, and 8 are significantly reduced, compared with the sizes of tags according to the conventional technique. In particular, the more groups for which a tag includes information, the more significantly the size of the tag is reduced.

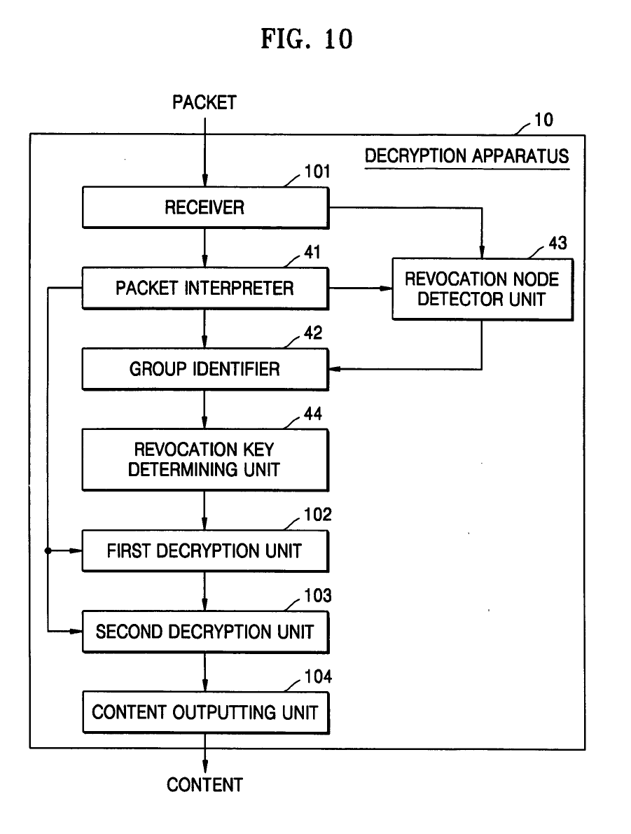

FIG. 10 is a block diagram of a decryption apparatus 10 according to an exemplary embodiment of the present invention.

Referring to FIG. 10, the decryption apparatus 10 according to the current exemplary embodiment of the present invention, which is an application of the revocation key determining apparatus 4 shown in FIG. 4, includes a receiver 101, a packet interpreter 41, a group identifying unit 42, a revocation node detector 43, a revocation key determining unit 44, a first decryption unit 102, a second decryption unit 103, and a content outputting unit 104. Accordingly, the above descriptions regarding the revocation key determining apparatus 4 illustrated in FIG. 4 are applied to the decryption apparatus 10 illustrated in FIG. 10, and therefore detailed descriptions thereof are omitted.

The receiver 101 receives a packet from a content server via a transmission medium, such as a network, etc.

The packet interpreter 41 interprets the packet received by the receiver 101 and determines the configuration of the packet according to the interpreted result.

The group identifying unit 42 identifies at least group of groups in the HBES key tree, on the basis of a HBES key tree structure determined according to the interpreted result of the packet interpreter 41.

The revocation node detector 43 detects whether one or more non-revoked nodes among nodes belonging to the group identified by the group identifying unit 42 are revoked on the basis of information regarding the interval of the non-revoked nodes.

The revocation key determining unit 44 determines whether HBES node key sets assigned to the nodes belonging to the group identified by the group identifying unit 42 are respectively revoked according to the result detected by the revocation node detector 43.

The first decryption unit 102 decrypts an encrypted content key recorded on a header 31 determined according to the interpreted result of the packet interpreter 41, using a HBES node key set determined as a non-revoked HBES node key set by the revocation key determining unit 44.

The second decryption unit 103 decrypts encrypted content recorded on a payload 32 determined according to the interpreted result of the packet interpreter 41, using the content key decrypted by the first decryption unit 102.

The content output unit 104 outputs the content decrypted by the second decryption unit 103 to a user. The content output unit 104 processes the content appropriately and outputs the processed result to the user. For example, if the content has a compressed format, the content output unit 104 decompresses the content and outputs the decompressed result to the user.

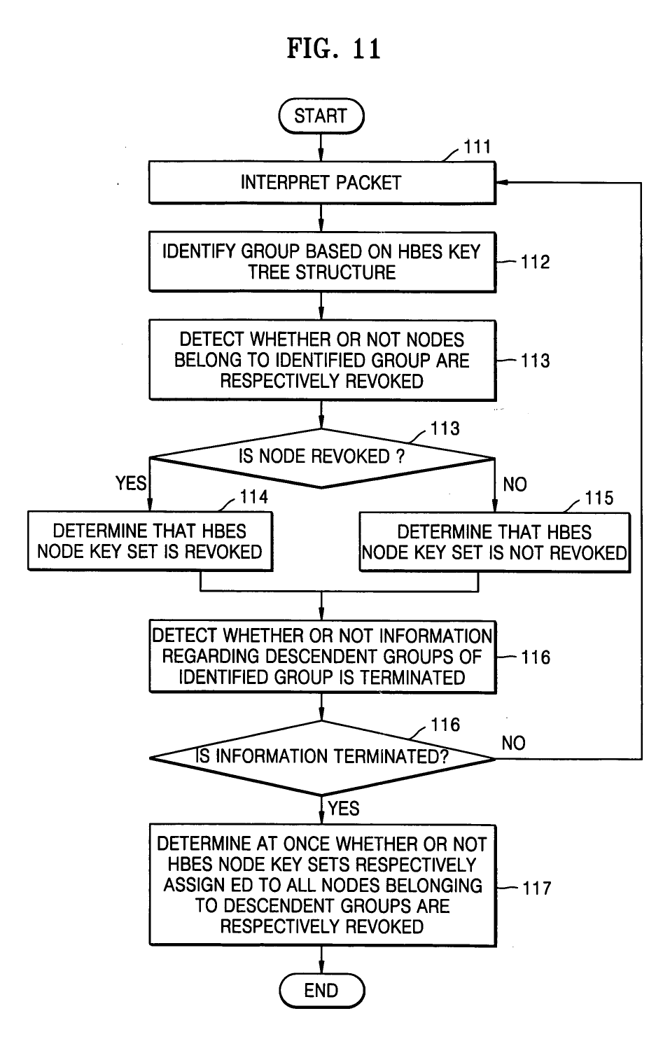

FIG. 11 is a flowchart illustrating a revocation key determining method according to an exemplary embodiment of the present invention.

Referring to FIG. 11, the revocation key determining method according to the current exemplary embodiment of the present invention includes operations which are sequentially processed by the revocation key determining apparatus 4 illustrated in FIG. 4, and therefore detailed descriptions thereof are omitted.

In operation 111, the revocation key determining apparatus 4 interprets a packet as illustrated in FIG. 3 and determines the configuration of the packet according to the interpreted result.

In operation 112, the revocation key determining apparatus 4 identifies at least one of a plurality of groups in the HBES key tree on the basis of a HBES key tree structure determined according to the interpreted result of operation 111. In more detail, in operation 112, the revocation key determining apparatus 4 identifies a group corresponding to the nearest lower layer of the layer, on the basis of the location of a node belonging to groups corresponding to one of a plurality of L layers

In operation 113, the revocation key determining apparatus 4 detects whether one or more non-revoked nodes among nodes belonging to the group identified in operation 112 are revoked, on the basis of information regarding the interval of the non-revoked nodes.

In operation 114, the revocation key determining apparatus 4 determines that a HBES node key set assigned to a node detected as a revoked node in operation 113 among HBES node key sets respectively assigned to nodes belonging to the group identified in operation 112 is revoked.

In operation 115, the revocation key determining apparatus 4 determines that HBES node key sets assigned to different nodes except for the node detected as the revoked node in operation 113 among HBES node key sets assigned to nodes belonging to the group identified in operation 112 are not revoked.

In operation 116, the revocation key determining apparatus 4 detects whether information regarding descendent groups of the group identified in operation 112 is terminated, and returns to operation 111 if the information regarding the descendent groups of the group identified in operation 112 is not terminated.

In operation 117, the revocation key determining apparatus 4 determines at once whether HBES node key sets assigned to all nodes belonging to the descendent groups are respectively revoked according to whether nodes belonging to the group identified in operation 112 are respectively revoked, if it is determined in operation 116 that the information regarding the descendent groups of the group identified in operation 116 is terminated.

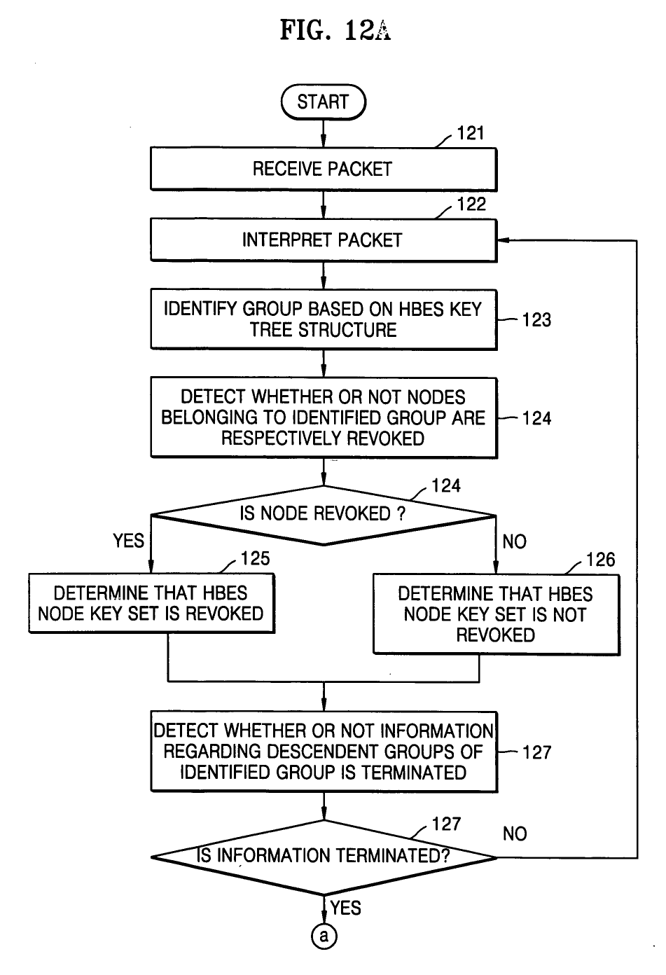

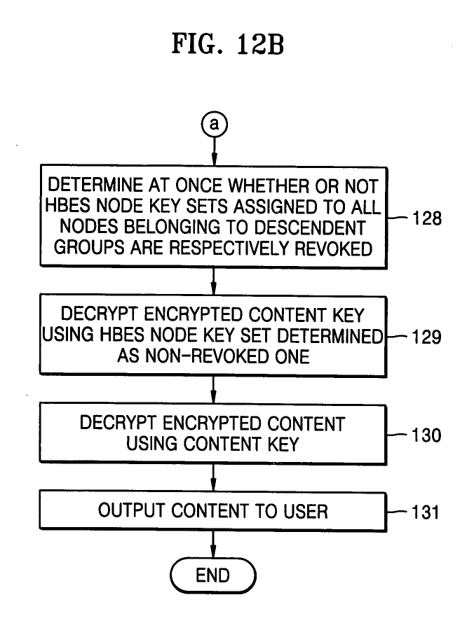

FIGS. 12A and 12B are flowcharts illustrating a decryption method according to an exemplary embodiment of the present invention.

Referring to FIGS. 12A and 12B, the decryption method includes operations which are sequentially processed by the decryption apparatus 4 illustrated in FIG. 4, and therefore detailed descriptions thereof are omitted.

In operation 121, the decryption apparatus 10 receives a packet via a transmission medium, such as a network, etc.

In operation 122, the decryption apparatus 10 interprets the packet received in operation 121 and determines the configuration of the packet according to the interpreted result.

In operation 123, the decryption apparatus 10 identifies at least one group among the plurality of groups in the HBES key tree on the basis of a HBES key tree structure determined according to the interpreted result of operation 122. In more detail, in operation 123, the decryption apparatus 10 identifies a group corresponding to the nearest lower layer of the layer on the basis of the location of node belonging to a group corresponding to any one of the L layers.

In operation 124, the decryption apparatus 10 detects whether one or more non-revoked nodes of nodes belonging to the group identified in operation 123 are revoked, on the basis of information regarding the interval of the one or more non-revoked nodes.

In operation 125, the decryption apparatus 10 determines that a HBES node key set assigned to a node detected as a revoked node in operation 124 among HBES node key sets assigned to the nodes belonging to the group identified in operation 123, is revoked.

In operation 126, the decryption apparatus 10 determines that HBES node key sets assigned to different nodes except for the node detected as the revoked node in operation 124 among the HBES node key sets assigned to the respective nodes belonging to the group identified in operation 123, are not revoked.

In operation 127, the decryption apparatus 10 detects whether information regarding the descendent groups of the group identified in operation 123 is terminated, and returns to operation 122 if the information regarding the descendent groups of the group identified in operation 123 is not terminated.

In operation 128, if it is determined in operation 127 that the information regarding the descendent groups of the group identified in operation 123 is terminated, the decryption apparatus 10 determines at once whether all HBES node key sets assigned to all nodes belonging to the descendent groups are revoked according to whether all nodes belonging to the group identified in operation 123 are revoked.

In operation 129, the decryption apparatus 10 decrypts an encrypted content key recorded in the header 31 determined according to the interpreted result of the packet interpreter 41, using a HBES node key set determined as a non-revoked HBES node key set in operations 126 and 128.

In operation 130, the decryption apparatus 10 decrypts encrypted content recorded on a payload 32 determined according to the interpreted result of the packet interpreter 41, using the content key decrypted in operation 129.

In operation 131, the decryption apparatus 10 outputs the content decrypted in operation 130 to a user.

The exemplary embodiments of the present invention as described above can also be created by a program which can be executed on a computer, and embodied on a universal digital computer for executing the program using a computer readable recording medium. Also, the data structures used in the exemplary embodiments of the present invention can be recorded through various means on a computer readable recording medium.

The computer readable medium includes, for example, magnetic storage media (e.g., ROM's, floppy disks, hard disks, etc.), optically readable media (e.g., CD-ROMs, DVDs, etc.) and carrier waves (e.g., transmissions over the Internet).

According to the exemplary embodiment of the present invention, by identifying a group on the basis of a HBES key tree structure, it is possible to remove group ID's that require a large number of bits using a conventional technique and thus reduce the size of a tag on which information regarding whether a HBES node key is revoked is written.

Also, according to the exemplary embodiment of the present invention, by introducing a field which indicates whether information regarding descendent groups of a group in a HBES key tree is terminated so that information regarding descendent groups no longer needs to be represented, it is possible to further reduce the size of a tag on which information regarding whether a HBES node key is revoked is written.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A revocation key determining method comprising:
identifying at least one of a plurality of groups based on a structure in which the plurality of groups, each comprising nodes to which key sets for content protection are respectively assigned, are hierarchically arranged in a tree form;
detecting whether a node in the at least one identified group is revoked; and
determining whether a key set assigned to the node is revoked according to the detected result.

2. The method of claim 1, wherein in identifying at least one of the plurality of groups based on the structure in which the plurality of groups, each comprising nodes to which key sets for content protection are respectively assigned, are hierarchically arranged in the tree form, based on the location of a node belonging to a group corresponding to a first layer of a plurality of layers, a group corresponding to a nearest lower layer of the first layer is identified.

3. The method of claim 1, wherein in detecting whether a node in the at least one identified group is revoked, determining whether information regarding descendent groups of the at least one identified group is terminated; and
in determining whether a key set assigned to the node is revoked according to the detected results, if it is determined that the information regarding the descendent groups is terminated, immediately determining whether key sets respectively assigned to all nodes belonging to the descendent groups are respectively revoked.

4. The method of claim 3, wherein in detecting whether a node in the at least one identified group is revoked, if the identified group is a “Leaf” group, if all nodes belonging to the descendent groups of the identified group are revoked, or if no node belonging to the descendent groups of the identified group is revoked, determining that the information regarding the descendent groups is terminated.

5. The method of claim 1, wherein in detecting whether a node in the at least one identified group is revoked, determining whether the nodes are respectively revoked based on information regarding an interval of one or more non-revoked nodes among the nodes.

6. The method of claim 1, wherein the at least one group is a group of nodes to which key sets, each comprising a seed value and values obtained by hashing the seed value and different seed values at different times, are respectively assigned.

7. The method according to claim 1, wherein said tree form comprises a Hierarchical Hash-chain Broadcast Encryption Scheme (HBES).

8. A revocation key determining apparatus comprising:
an identifying unit which identifies at least one of a plurality of groups based on a structure in which the plurality of groups, each comprising nodes to which key sets for content protection are respectively assigned, are hierarchically arranged in a tree form;
a detector which detects whether a node belonging to the at least one group identified by the identifying unit is revoked; and
a determining unit which determines whether the key set assigned to the node is revoked according to the result detected by the detector.

9. The apparatus of claim 8, wherein based on the location of a node belonging to a group corresponding to a first layer of a plurality of layers, the identifying unit identifies a group corresponding to a nearest lower layer of the first layer.

10. The apparatus of claim 8, wherein the detector detects whether information regarding descendent groups of the identified group is terminated, and
wherein the determining unit immediately determines whether key sets respectively assigned to all nodes belonging to the descendent groups are respectively revoked if the detector detects that the information regarding the descendent groups is terminated.

11. The apparatus according to claim 8, wherein said tree form comprises a Hierarchical Hash-chain Broadcast Encryption Scheme (HBES).

12. A computer-readable medium having embodied thereon a computer program for executing a revocation key determining method, the method comprising:
identifying at least one of a plurality of groups based on a structure in which the plurality of groups, each comprising nodes to which key sets for content protection are respectively assigned, are hierarchically arranged in a tree form; and
detecting whether a node in the at least one identified group is revoked; and
determining whether the key set assigned to the node is revoked according to the detected result.

13. A computer-readable medium according to claim 12, wherein said tree form comprises a Hierarchical Hash-chain Broadcast Encryption Scheme (HBES).

14. A decryption method comprising:
identifying at least one of a plurality of groups based on a structure in which the plurality of groups, each comprising nodes to which key sets for content protection are respectively assigned, are hierarchically arranged;
detecting whether a node belonging to the identified group is revoked;
determining whether the key set assigned to the node is revoked according to the detected result; and
decrypting encrypted content using a key set determined as a non-revoked key set.

15. The method of claim 14, wherein decrypting encrypted content using the key set determined as the non-revoked key set comprises:
decrypting an encrypted content key using the key set determined as the non-revoked key set; and
decrypting the encrypted content using the decrypted content key.

16. The method according to claim 14, wherein said tree form comprises a Hierarchical Hash-chain Broadcast Encryption Scheme (HBES).

17. A decryption apparatus comprising:
an identifying unit which identifies at least one of a plurality of groups based on a structure in which the plurality of groups, each comprising nodes to which key sets for content protection are respectively assigned, are hierarchically arranged in a tree form;
a detector which detects whether a node belonging to the group identified by the identifying unit is revoked;
a determining unit which determines whether the key set assigned to the node is revoked according to the result detected by the detector; and
a decrypting unit which decrypts encrypted content using a key set determined as a non-revoked key set.

18. The apparatus of claim 17, wherein the decrypting unit comprises:
a first decryption unit which decrypts an encrypted content key using the key set determined as the non-revoked key set by the determining unit;
a second decryption unit which decrypts the encrypted content using the content key decrypted by the first decryption unit.

19. The apparatus according to claim 17, wherein said tree form comprises a Hierarchical Hash-chain Broadcast Encryption Scheme (HBES).

20. A computer-readable medium having embodied thereon a computer program for executing a revocation key determining method, the method comprising:
identifying at least one of a plurality of groups based on a structure in which the plurality of groups, each comprising nodes to which key sets for content protection are respectively assigned, are hierarchically arranged in a tree form;
detecting whether a node belonging to the identified group is revoked;
determining whether the key set assigned to the nodes is revoked according to the detected result; and
decrypting encrypted content using a key set determined as a non-revoked key set.

21. The computer-readable medium according to claim 20, wherein said tree form comprises a Hierarchical Hash-chain Broadcast Encryption Scheme (HBES).

22. A computer-readable recording medium storing a data structure, the data structure comprising:
a first field which indicates whether information regarding descendent groups of one of a plurality of groups of nodes to which key sets for content protection are respectively assigned, is terminated; and
a second field which indicates whether nodes belonging to the group of the plurality of groups are respectively revoked.

23. The computer-readable recording medium of claim 22, wherein the first field indicates that the information regarding the descendent groups is terminated, if the group of the plurality of groups is a “Leaf” group, if all nodes belonging to the descendent groups of the group of the plurality of groups are revoked, or if no node belonging to the descendent groups of the group of the plurality of groups is revoked.
